(19) United States
(12) Patent Application Publication
(10) Pub. No.: US 2025/0190981 A1
(43) Pub. Date: Jun. 12, 2025

(54) QUANTUM-RESISTANT SECURITY PROVISIONS FOR OFFLINE DIGITAL PAYMENTS

(71) Applicant: CRUNCHFISH DIGITAL CASH AB, Malmo (SE)

(72) Inventor: Paul CRONHOLM, Malmo (SE)

(21) Appl. No.: 18/846,261

(22) PCT Filed: Mar. 31, 2023
(86) PCT No.: PCT/SE2023/050294

§ 371 Date: Sep. 12, 2024

(30) Foreign Application Priority Data
Mar. 31, 2022 (SE) 2250413-8

(51) Int. Cl. G06Q 20/38

(52) U.S. Cl. CPC G06Q 20/3829; G06Q 20/38215; G06Q 20/3825

(57) ABSTRACT

In a, computerized method (200), payer and payce communication devices (PD, PD2) negotiate (210) payment details for an offline digital payment by exchanging a payment request (112) and a payment response (114) by short-range data communication. For data integrity, the negotiation involves performing a predefined cryptographic operation for the payment request (112) as well as the payment response (114). The cryptographic operation is based on payment-specific data and a first cryptographic key (masterkey) being a shared secret stored in respective trusted execution environments (16, 26) of the payer and payce communication devices (PD, PD2). Upon successful negotiation, the payer and/or payee communication device (PD, PD2), store(s) (220) the payment details for the offline digital payment in the trusted execution environment (16, 26). The payer and/or payee communication device (PD, PD2) subsequently make(s) a payment settlement request (122, 122′; 748, 778) by broadband data communication with a computerized payer or payee account provider (60; Issuer, 70; Issuer2), respectively. The payment settlement request (122, 122′; 748, 778) includes the stored negotiated payment details for the offline digital payment and is signed by a second or third cryptographic key (wallet_priv_key, wallet2_priv_key), which is stored in the trusted execution environment (16, 26) of the payer or payee communication device (PD, PD2), respectively.

### TECHNICAL FIELD

The present invention generally relates to digital security. More particularly, the present invention relates to quantum-resistant security provisions for handling offline digital payments. Even more particularly, the present invention relates to an associated digital payment system, a communication device for use therein, computing resources, a computerized method, computer program products and non-volatile computer readable media.

### BACKGROUND

The technical field of digital communication has seen an overwhelming market penetration during the last decades. Digital communication is typically enabled between one or more mobile communication devices over wide-area networks, WAN, for instance via cellular radio systems like 5G, UMTS or GSM, or over wireless local area networks, WLAN. Alternatively, digital communication may be enabled over various short-range wireless data communication standards, such as Bluetooth or WiFi. As used in this document, the term “communication device” includes a mobile communication device, a mobile phone, a smart phone, a tablet computer, a personal digital assistant, a portable computer, smart glasses, a smart wearable (e.g. smart watch or smart bracelet), a smart card, a payment terminal, a service terminal, a point-of-sales terminal, a checkout counter, a delivery pickup point, a vending machine, a ticket machine, a dispensing machine and an access control system, without limitation.

As is well known, information being exchanged between devices by means of digital communication must be secured. Information security can be described as a suite of protocols, standards and algorithms established to secure traffic between devices communicating using any of the means discussed above. Two fundamental goals of achieving information security involve the provision of confidentiality for preventing data theft, and integrity for assuring that data is not tampered with or altered during transmission thereof. Data integrity furthermore involves being able to confirm the identity of a device sending data, also referred to as authenticity.

In order to achieve data confidentiality and integrity, companies, organizations and other professionals in the field of information security have over the years established a number of security standards that are considered “secure”, i.e. at least generally insusceptible to existing security threats. However, new security threats are still appearing which lead to big data breaches occurring every now and then. Accordingly, the security standards have to be up to date at all times and at least theoretically proven secure.

A known security standard for providing data confidentiality is the application and utilization of encryption algorithms. Many modern encryption algorithms (typically asymmetric public-key algorithms) rely on simple modular arithmetic in their implementations, and more specifically either one of three mathematical problems: the prime (integer) factorization problem, the discrete logarithm problem, or the elliptic-curve problem. As an example, the RSA (Rivet-Shamir-Adleman) public-key encryption method is based on the prime factorization problem. In another example, some lattice-based cryptography methods rely on the discrete logarithm problem. In yet another example, the elliptic-curve Diffie-Hellman key exchange method is based on the elliptic curve problem.

Although the mathematical problems discussed above are considered practically unsolvable by today's machines, the future introduction of quantum computing may pose a serious threat to security standards being based on the insolvability of these mathematical problems. It is therefore of paramount importance that the cryptography schemes of the future are so called quantum-resistant, i.e. cannot be solved by means of quantum computing. The term “quantum-resistant” refers to the established security configuration being uncrackable by means of a quantum computer. The distinction is important to add, particularly since some PKI (Public key infrastructure) configurations are not post-quantum resistant whereas some others are. A plurality of different post-quantum models exist today in theory, many of which can be realized in practice whenever quantum computing is possible. For instance, post-quantum models include the quantum gate (e.g. as implemented by Shor's algorithm), the adiabatic model, the measurement-based quantum computation (MBQC), the unitary circuit, the discrete-time quantum walk, or the quantum annealer (i.e. a machine that realizes the effect of quantum annealing), to name a few. Accordingly, a sufficiently powerful machine utilizing the collective properties of quantum states, e.g. superposition, interference and entanglement, for performing calculations will, at least in theory, be able to solve all of the mathematical problems discussed above and thus crack established encryption algorithms that are considered secure as of today.

A technical field for which post-quantum cryptography is immediately crucial is digital communication relating to digital payments. Digital payments in general, and digital proximity payments in particular, allow a user of a mobile communication device to make a digital payment when being physically proximate to another entity at a physical place such as, for instance, a shop, restaurant, theatre, sport arena, workshop, or any other place where a human may want to perform a digital payment. The other entity may be another communication device which is controlled by a human user (such as a smart phone, tablet, point-of-sales terminal, checkout counter, etc.), or another communication device that operates more autonomously (such as a service terminal, vending machine, ticket machine, access control system, etc.). Throughout this document, the term “digital payment” is to be construed broadly to embrace any kind of transfer of economic value in digital form on behalf of or between people of any types, roles etc.

If the confidentiality of a digital payment cannot be established, monetary value can be stolen. If the integrity of a user participating in a digital exchange of monetary value is breached, it is neither possible to trust a user making a payment request nor the data (for instance money) associated with the request. Quantum-resistant cryptography methods for digital payments are therefore especially desired.

For digital payments, several other aspects also have to be taken into account when designing quantum-resistant cryptography methods. In particular, some digital payment services offer offline digital payments. An offline transaction works even if neither the payer nor the payee has access to the internet, do not have mobile network coverage or are not connected to a payment service backend. Enabling offline transactions involve differentiating between an offline payment at the moment when the payer and the payee meet in physical proximity of each other and exchange data representing payment details by short-range data communication, and a subsequent online payment settlement involving the transfer of money in the cloud. In order to have funds to use offline the users can reserve money in, for instance, their bank or card accounts for offline use, or arrange credit for offline payments. This can be seen as the digital equivalent of withdrawing money at an automated teller machine, ATM, and carrying physical cash around in a wallet. The digital money may be placed in a mobile (digital) wallet and can be used in the same way as physical cash. Accordingly, offline digital payments may support national central banks' plans for a future value-based e-currency. Offline digital payments work just as well for a peer-to-peer case, where the mobile transaction is done straight to an app on the payee's mobile communication device, as it does for a business-to-consumer, B2C, case, where the mobile transaction goes from a customer via, for instance, a payment terminal to a physical cash register operated by a merchant in store. At the moment of payment, the transaction is digitally signed by the payer and transmitted locally to the payee, so the payee has a digitally signed commitment which can be seen as a digital equivalent of a banker's cheque as it is guaranteed. If both parties are offline at the moment of payment, the transfer of money between accounts will take place later when one of the parties has internet connection and access to the payment service's back-end in the cloud.

As realized from the discussion above, offline digital payments have limitations with respect to both storage capacity and bandwidth. Considering that the payer and/or payee device must be able to at least log transactions and exchange data representing payment details, the devices furthermore must allow for storage of security-related data. For instance, the bandwidth provided by NFC (Near-frequency communication) is typically limited to 106, 212, or 424 kbit/s, and some devices, e.g. smart cards, are only capable of storing a couple of hundred kilobytes. There are thus problems with some security-related data not being suitable for some devices or for conducting offline payments.

Accordingly, a novel way of defining quantum-resistant security standards in offline digital payment systems is therefore much desired, which also takes the above considerations related to bandwidth and storage capacity into account. The present inventor has accordingly realized that there is room for improvements with respect to the observations described herein.

### SUMMARY

In line with the observations above, the present inventor has made valuable technical insights to solve or at least mitigate one or more of the challenges referred to in the previous section. These insights will be presented as inventive aspects below as well as in the detailed description section, the claims and the drawings. The list of inventive aspects is not to be seen as exhaustive but rather a summary of particularly beneficial inventive aspects.

In a nutshell, the present invention offers a new paradigm for offline digital payments that addresses the challenges which can be expected in the era of quantum computing. The invention combines two different data integrity schemes. First, payment details for an offline digital payment are negotiated by short-range data communication between payer and payee communication devices using a secure cryptographic key as a shared secret that allows each device to verify the offline payment request and response being exchanged between the devices. Successfully negotiated payment details are stored locally and securely in the device. Subsequently, the device makes a payment settlement request by broadband data communication with an issuer or account provider associated with the payer or payee. The data integrity of the payment settlement request is preserved by signing the request with another secure cryptographic key. The approach is lean in bandwidth and local storage requirements for the offline part of the payment, yet secure because the shared secret is not known to the issuer a.k.a. account provider, nor to any other network entity that handles the settlement request.

A first inventive aspect is a digital payment system. The digital payment system comprises a payer communication device and a payee communication device, each having a short-range data communication interface, a broadband data communication interface and a trusted execution environment enabled for performing a predefined cryptographic operation. The digital payment system further comprises a computerized payer account provider being a cloud-based computing resource capable of broadband data communication. The digital payment system moreover comprises a computerized payee account provider being a cloud-based computing resource capable of broadband data communication. The trusted execution environment of the payer communication device comprises a first cryptographic key being a shared secret between the payer and payee communication devices, and a second cryptographic key. The trusted execution environment of the payee communication device comprises said first cryptographic key being the shared secret between the payer and payee communication devices, and a third cryptographic key. The payer communication device and the payee communication device are configured to negotiate payment details for an offline digital payment by exchanging a payment request and a payment response by short-range data communication. The negotiation involves the payer communication device: verifying the payment request by performing the predefined cryptographic operation based on payment-specific data included in the payment request as well as on the first cryptographic key and comparing with cryptographic data also included in the payment request and being the result of the payee communication device having performed the same predefined cryptographic operation based on said payment-specific data as well as on said first cryptographic key. The negotiation further involves the payee communication device verifying the payment response by performing the predefined cryptographic operation based on payment-specific data included in the payment response as well as on the first cryptographic key and comparing with cryptographic data also included in the payment response and being the result of the payer communication device having performed the same predefined cryptographic operation based on said payment-specific data as well as on said first cryptographic key. At least one of the payer communication device and the payee communication device is configured to: upon successful verification of the payment request or the payment response, respectively, store the payment-specific data included in the payment response as negotiated payment details for the offline digital payment in the trusted execution environment, and subsequently make a payment settlement request by broadband data communication with the computerized payer account provider or the computerized payee account provider, respectively, the payment settlement request including the stored negotiated payment details for the offline digital payment and being signed by the second cryptographic key or third cryptographic key, respectively.

A second inventive aspect is a communication device for use in a digital payment system. The communication device comprises a short-range data communication interface, a broadband data communication interface, and a trusted execution environment enabled for performing a predefined cryptographic operation. The trusted execution environment comprises a first cryptographic key being a shared secret, and an additional cryptographic key. The communication device is configured to act either for a payer or for a payee to negotiate payment details for an offline digital payment by exchanging a payment request and a payment response by short-range data communication with another communication device. The negotiation involves, when the communication device acts for the payer, verifying the payment request by performing the predefined cryptographic operation based on payment-specific data included in the payment request as well as on the first cryptographic key and comparing with cryptographic data also included in the payment request and being the result of said another communication device having performed the same predefined cryptographic operation based on said payment-specific data as well as on said first cryptographic key. The negotiation involves, when the communication device acts for the payee, verifying the payment response by performing the predefined cryptographic operation based on payment-specific data included in the payment response as well as on the first cryptographic key and comparing with cryptographic data also included in the payment response and being the result of the payer communication device having performed the same predefined cryptographic operation based on said payment-specific data as well as on said first cryptographic key. The communication device is configured, upon successful verification of the payment request or the payment response, respectively, to store the payment-specific data included in the payment response as negotiated payment details for the offline digital payment in the trusted execution environment. The communication device is configured to subsequently send a payment settlement request by broadband data communication, the payment settlement request including the stored negotiated payment details for the offline digital payment and being signed by the additional cryptographic key.

A third inventive aspect is a computing resource being configured to perform the functionality of the computerized payer account provider in the digital payment system as defined in the first inventive aspect.

A fourth inventive aspect is a computing resource being configured to perform the functionality of the computerized payee account provider in the digital payment system as defined in the first inventive aspect. A fifth inventive aspect is a computerized method of handling an offline digital payment. The method comprises a payer communication device and a payee communication device negotiating payment details for an offline digital payment by exchanging a payment request and a payment response by short-range data communication. The negotiation involves performing a predefined cryptographic operation for the payment request as well as the payment response, the cryptographic operation being based on payment-specific data as well as on a first cryptographic key which is a shared secret being stored in respective trusted execution environments of the payer communication device and payee communication device. At least one of the payer communication device and the payee communication device, upon successful negotiation, stores the payment details for the offline digital payment in the trusted execution environment. Said at least one of the payer communication device and the payee communication device subsequently makes a payment settlement request by broadband data communication with a computerized payer account provider or computerized payee account provider, respectively. The payment settlement request includes the stored negotiated payment details for the offline digital payment and is signed by a second cryptographic key or third cryptographic key, respectively, which is stored in the trusted execution environment of the payer communication device or payee communication device, respectively.

A sixth inventive aspect is a computer program product comprising computer program code for performing the functionality of the payer communication device in the method according the fifth inventive aspect when the computer program code is executed by a processing device.

A seventh inventive aspect is a computer program product comprising computer program code for performing the functionality of the payee communication device in the method according the fifth inventive aspect when the computer program code is executed by a processing device.

An eight inventive aspect is a computer program product comprising computer program code for performing the functionality of the computerized payer account provider in the method according the fifth inventive aspect when the computer program code is executed by a processing device.

A ninth inventive aspect is a computer program product comprising computer program code for performing the functionality of the computerized payee account provider in the method according the fifth inventive aspect when the computer program code is executed by a processing device.

A tenth inventive aspect is a non-volatile computer readable medium having stored thereon a computer program comprising computer program code for performing the functionality of the payer communication device in the method according to the fifth inventive aspect when the computer program code is executed by a processing device.

An eleventh inventive aspect is a non-volatile computer readable medium having stored thereon a computer program comprising computer program code for performing the functionality of the payee communication device in the method according to the fifth inventive aspect when the computer program code is executed by a processing device.

A twelfth inventive aspect is a non-volatile computer readable medium having stored thereon a computer program comprising computer program code for performing the functionality of the computerized payer account provider in the method according to the fifth inventive aspect when the computer program code is executed by a processing device.

A thirteenth inventive aspect is a non-volatile computer readable medium having stored thereon a computer program comprising computer program code for performing the functionality of the computerized payee account provider in the method according to the fifth inventive aspect when the computer program code is executed by a processing device.

As used in this document, the term “short-range data communication” includes any form of proximity-based device-to-device communication, unidirectional or bidirectional. This includes radio-based short-range wireless data communication such as, for instance, Bluetooth, BLE (Bluetooth Low Energy), RFID, WLAN, WiFi, mesh communication or LTE Direct, without limitation. It also includes non-radio-based short-range wireless data communication such as, for instance, magnetic communication (such as NFC), audio communication, ultrasound communication, or optical communication (such as QR, barcode, IrDA).

As used in this document, the term “wide area network communication” (abbreviated as “WAN communication”) includes any form of data network communication with a party which may be remote (e.g. cloud-based), including cellular radio communication like W-CDMA, GSM, UTRAN, HSPA, LTE, LTE Advanced or 5G, possibly communicated as TCP/IP traffic, or via a WLAN (WiFi) access point, without limitation. Moreover, the terms “long-range data communication” and “broadband data communication” are considered as synonyms of “wide-area network communication”.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question.

Other aspects, objectives, features and advantages of the inventive aspects will appear from the following detailed disclosure as well as from the claims and the drawings. Generally, all terms used herein are to be interpreted according to their ordinary meaning in the technical field, unless explicitly defined otherwise herein.

All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1 is a schematic block diagram of a digital payment system.

FIG. 2 is a schematic flowchart diagram of a computerized method of handling an offline digital payment.

FIG. 3 is a schematic illustration of a computer-readable medium in one exemplary embodiment, capable of storing a computer program product.

FIG. 4 illustrates onboarding activities for a computerized payer account provider according one embodiment.

FIG. 5 illustrates activities for provisioning a trusted application in one embodiment.

FIG. 6A illustrates activities for onboarding of a payer communication device in one embodiment.

FIG. 6B illustrates a topup procedure topup for a payer digital wallet in the payer communication device in one embodiment.

FIG. 7A illustrates activities for performing an offline digital payment according to one embodiment.

FIG. 7B illustrates activities for causing settlement of an offline digital payment according to one embodiment.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like reference signs refer to like elements.

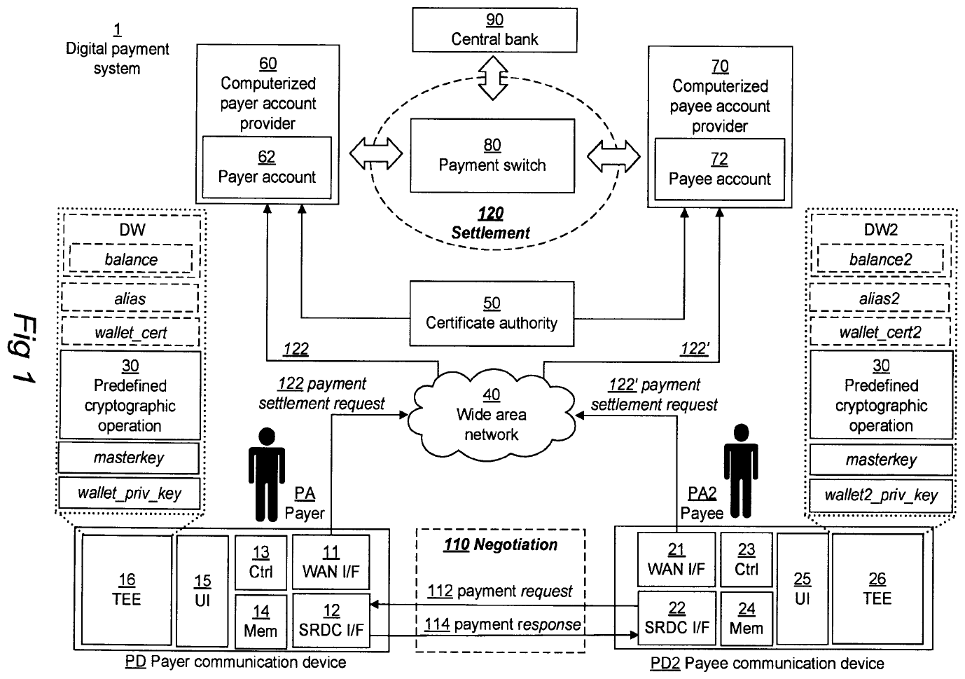

FIG. 1 illustrates an exemplary embodiment of a digital payment system 1 for handling one or more offline digital payments. The offline digital payment relates to an exchange of monetary value between a payer PA and a payee PA2.

The payer PA and the payee PA2 may typically be human users. However, it is also envisaged that one or both of the payer PA and payee PA2 may be automated machines or incarnations of artificial intelligence. The payer PA and the payee PA2 are represented by aliases alias and alias2, respectively, in the digital payment system 1. The aliases alias and alias2 may, for instance, be email addresses, social media accounts, etc.

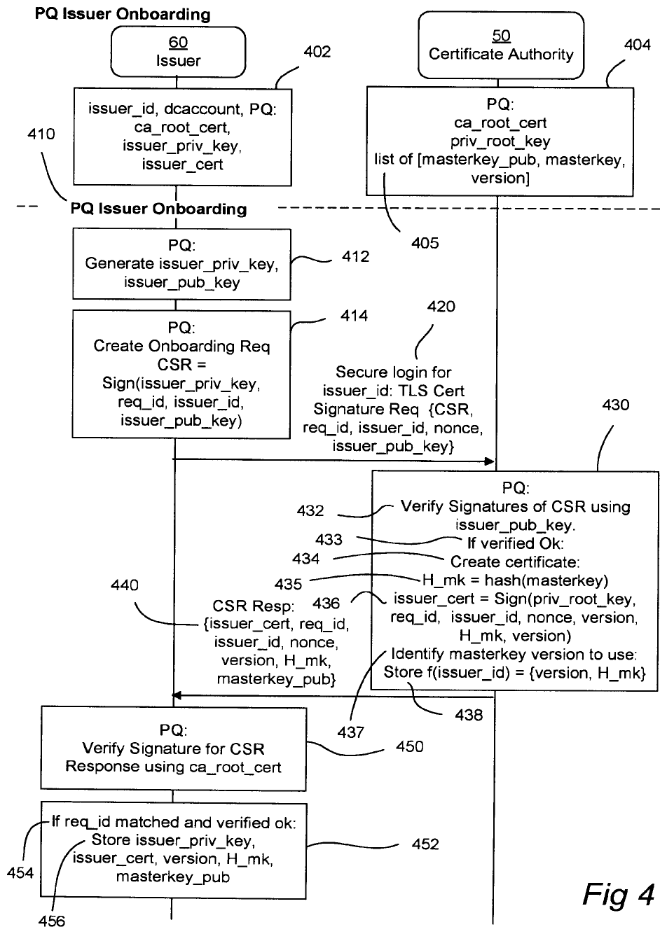

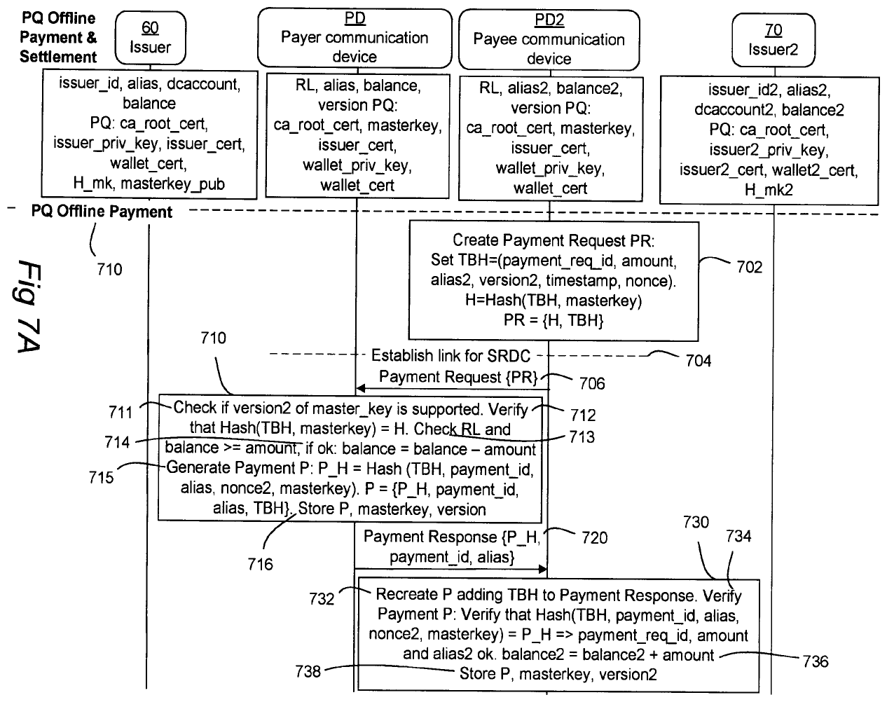

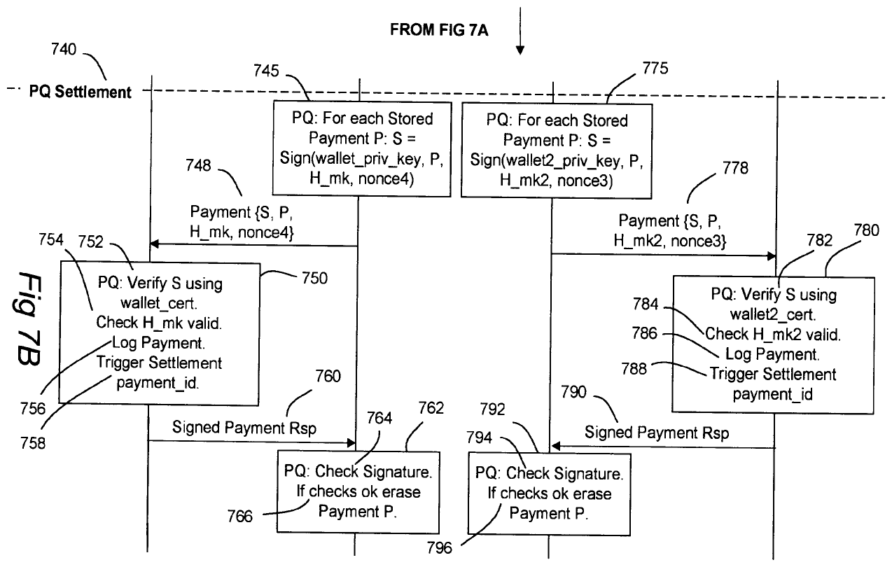

The digital payment system 1 comprises a computerized payer account provider 60, which in the present disclosure is also being referred to as Issuer (cf. FIGS. 4-7). The digital payment system 1 also comprises a computerized payee account provider 70, which in the present disclosure is also being referred to as Issuer2 (cf. FIGS. 7A-B). The computerized payer account provider 60 and the computerized payee account provider 70 are preferably cloud-based computing resources, for instance operated by respective banks or similar financial institutions. Each one of the computerized payer account provider 60 and the computerized payee account provider 70 is capable of (i.e., enabled or configured for) broadband data communication.

In some embodiments, the computerized payer account provider 60 and the computerized payee account provider 70 are the same account provider, i.e. a common account provider for the payer PA and payee PA2.

The digital payment system 1 further comprises a payment switch 80 and a central bank 90. The payment switch 80 and the central bank 90 are, in conjunction with the computerized payer account provider 60 and the computerized payee account provider, responsible for handling a payment settlement 120. The payment switch 80 is invoked by either one of the computerized payer or payee account providers 60, 70 for initiating the settlement 120. The settlement 120 then transfers monetary value from a payer account 62 maintained by the computerized payer account provider 60, to a payee account 72 maintained by the computerized payee account provider 70. The central bank 90 is also involved in the settlement 120, for instance by carrying out monetary policies or controlling monetary supplies. An implementation of a payment settlement 120 according to particular embodiment is shown in FIG. 7A and will be described later on in this document.

The digital payment system 1 further comprises a payer communication device PD for use by the payer PA and a payee communication device PD2 for use by the payee PA2. As seen in FIG. 1, each one of the payer communication device PD and the payee communication device PD2 comprises a plurality of computerized units. The skilled person appreciates that the components of the payer communication device PD and the payee communication device PD2 sharing the same name are configured to operate similarly, i.e. broadband data communication interfaces WAN I/F 11; 21, short-range data communication interfaces SRDCI/F 12; 22, controllers Ctrl 13; 23, local storages including memories 14; 24 and user interfaces 15; 25.

Of course, the skilled person realizes that the components illustrated in FIG. 1 is just one potential embodiment of the payer communication device PD and the payee communication device PD2. The scope of the present disclosure is not limited to these particular components and/or configurations. Alternative embodiments may thus be realized for either one of them, provided that they are suitable for handling offline digital payments. To this end, the payer communication device PD and/or the payee communication device PD2 may be implemented in the form of, for instance, a mobile communication device, a mobile phone, a smart phone, a tablet computer, a personal digital assistant, a portable computer, smart glasses, a smart wearable (e.g. smart watch or smart bracelet), a smart card, a payment terminal, a service terminal, a point-of-sales terminal, a checkout counter, a delivery pickup point, a vending machine, a ticket machine, a dispensing machine and an access control system, without limitation. Moreover, as discussed in the background section, offline digital payments may be effected in both peer-to-peer cases, where the mobile transaction is done straight to an app on the payee's mobile communication device, and in business-to-consumer, B2C, cases, where the mobile transaction goes from a customer via, for instance, a payment terminal to a physical cash register operated by a merchant in store.

The WAN I/Fs 11; 21 may be configured for wide area network communication compliant with, for instance, one or more of W-CDMA, GSM, UTRAN, HSPA, LTE, LTE Advanced or 5G, and TCP/IP, and/or WLAN (WiFi), without limitation.

The SRDC I/Fs 12; 22 may be configured for Bluetooth communication, or any other radio-based short-range wireless data communication such as, for instance, Bluetooth Low Energy, RFID, WLAN, WiFi, mesh communication or LTE Direct, without limitation, or any non-radio-based short-range wireless data communication such as, for instance, magnetic communication (such as NFC), (ultra) sound communication, or optical communication (such as IrDA) without limitation. In some embodiments, the SRDC I/Fs 12; 22 comprise equipment and functionality for presenting or scanning a QR code.

The controllers 13; 23 comprise one or more processing units. The controllers 13; 23 may be implemented in any known controller technology, including but not limited to microcontroller, processor (e.g. PLC, CPU, DSP), FPGA, ASIC or any other suitable digital and/or analog circuitry capable of performing the intended functionality.

The memories 14; 24 may be implemented in any known memory technology, including but not limited to ROM, RAM, SRAM, DRAM, CMOS, FLASH, DDR, SDRAM or some other memory technology. In some embodiments, the memories 14; 24 or parts thereof may be integrated with or internal to the controllers 13; 23, and more specifically the processing units thereof. The memories 14; 24 may store program instruction for execution by the controllers 13; 23, and more specifically the processing units thereof, as well as temporary and permanent data.

The user interfaces 15; 25 may comprise an input device and a presentation device, as is generally known per se. In some embodiments, the input device and the presentation device are constituted by one common physical device, such as for instance a touch screen (touch-sensitive display screen), implemented in for instance resistive touch technology, surface capacitive technology, projected capacitive technology, surface acoustic wave technology or infrared technology.

The payer communication device PD and the payee communication device PD2 further comprise a respective trusted execution environment (TEE) 16; 26, such as a secure element, i.e. a tamper-resistant hardware or virtual platform. The TEEs 16; 26 are configured to securely host applications, i.e. trusted applications, and to store confidential and cryptographic data and therefore provide a trusted environment for execution of such applications. This is commonly referred to as secure runtime. Advantageously, some of the data and functionality in embodiments of the invention may be stored in and performed by the TEEs 16; 26 of the devices PD, PD2.

The TEEs 16; 26 may be configured according to any hardware-based computer architecture schemes known in the art, including but not limited to Samsung TEEGRIS, Qualcomm TEE, Huawei iTrustee, Trustonic Kinibi, Google Open Source Trusty, Open Portable TEE, Nvidia's Trusted Little Kernel for Tegra, Sierra TEE, ProvenCore TEE, Trusty TEE for Android, or TrustKernel T6. Moreover, the TEEs 16; 26 may be adapted to protect hardware resource of the devices PD, PD2 by implementing any hardware support technologies known in the art, including but not limited to Arm's TrustZone, MultiZone Security, AMD Platform Security Processor, Intel Software Guard Extensions, Apple's Secure Enclave Processor, or Google's Titan M.

The TEEs 16; 26 may alternatively be configured according to any software-based computer architecture schemes known in the art, such as the virtual execution environment being disclosed in the European patent EP 2 795 829 B1. In this case, the trusted execution environments TEEs 16; 26 may be implemented in software and may reside in the local storage of the devices PD, PD2 or even the memories 14; 24.

As further seen in FIG. 1, the payer communication device PD as well as the payee communication device PD2 comprise a selection of cryptographic keys and a predefined cryptographic operation 30. The present inventor has meticulously selected and considered these security provisions in view of the problems discussed in the background section. Not only is quantum-resistant information security desired, but also an appropriate security scheme in view of the existing broadband and/or storage limitations associated with offline digital payments. To this end, encryption schemes based on PKI (Public key infrastructure) are associated with relatively complex and storage-demanding keys. As an example, it is not uncommon that public keys require several hundred kilobytes of storage capacity. Moreover, the public keys can be cracked by means of quantum computing. It is thus realized that such schemes are not suitable to be implemented when performing quantum-resistant offline digital payments by certain devices being associated with a limited storage/bandwidth capacity, such as smart cards or smart chips. However, longer keys may advantageously be used upon an online settlement occurring, i.e. after the offline exchange, provided that quantum-resistant properties can be assured for said longer keys. Accordingly, a mix of security standards have been selected having the combined technical effect of providing quantum-resistant means for offline digital payments. During an offline negotiation 110 of payment details, the digital payment system 1 therefore utilizes a quantum-resistant predefined cryptographic operation 30 which is based on a first cryptographic key masterkey, being a shared secret. During an online settlement 120, however, the digital payment system instead utilizes quantum-resistant asymmetric encryption.

For systems not having a limited bandwidth and/or storage capacity, quantum-resistant asymmetric encryption could potentially be used during the entire procedure. As has been discussed herein, however, this is not appropriate in the present digital payment system 1. The first cryptographic key masterkey could in alternative solutions be shared online. However, it is desired to keep this a secret in the respective TEEs 16, 26 of the payer/payee communication devices PD, PD2 for security reasons. The selective transition from the predefined cryptographic operation 30 based on the first cryptographic key masterkey during offline exchange of data, to quantum-resistant asymmetric encryption during online settlement, is therefore a particularly inventive concept associated with the present disclosure.

In one or more embodiments, the predefined cryptographic operation 30 and the first cryptographic key masterkey are based on one or more symmetric cryptography methods. Symmetric encryption methods are proven to be inherently secure against attacks performed by quantum computers. For instance, symmetric encryption methods used by the predefined cryptographic operation 30 may involve AES256 or Twofish256, or other suitable quantum-resistant symmetric encryption methods.

In one or more embodiments, the predefined cryptographic operation 30 is a quantum-resistant cryptographic hash function being configured to hash the first cryptographic key masterkey together with other data as will be described later on in this document. Much like symmetric encryption methods, hash functions are proven to be inherently secure against attacks performed by quantum computers. For instance, the predefined cryptographic operation 30 may be an HMAC based on e.g. SHA2, SHA3, SHA256, SHA512. Hashing two times, as is the case for an HMAC, may be particularly suitable in order to prevent length extension attacks. Additionally, a salt may be included in the predefined cryptographic hash operation 30 in order to provide protection against hash table attacks and also to slow down offline dictionary and brute-force attacks.

Regardless of whether quantum-resistant symmetric encryption or quantum-resistant hash functions are used, integrity can be assured for the first cryptographic key masterkey even in future scenarios wherein computers implement quantum computing methods, such as either one of those described in the background section.

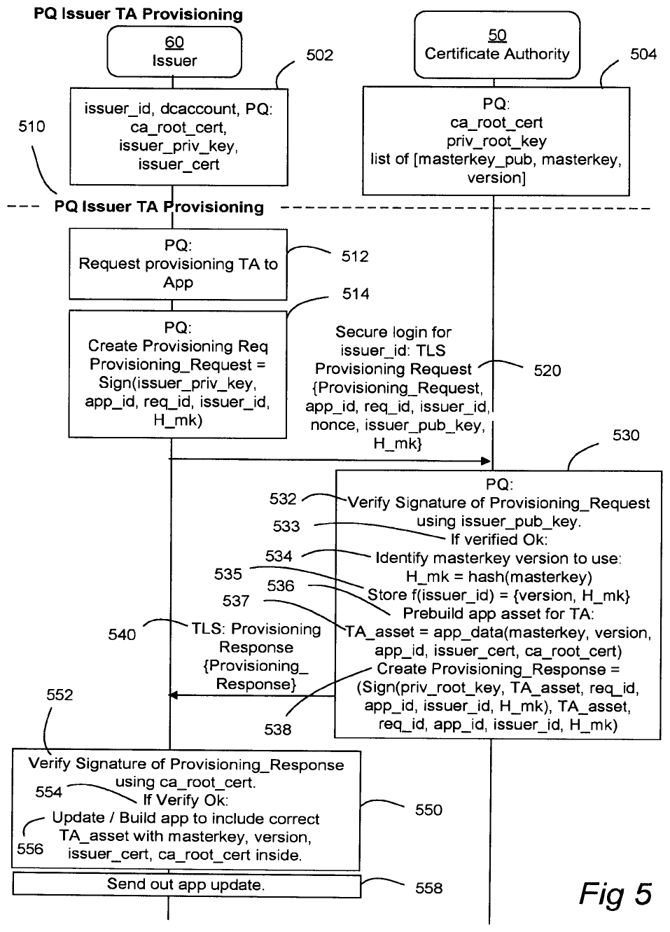

Each one of the TEEs 16; 26 comprises the first cryptographic key masterkey and the predefined cryptographic operation 30. The first cryptographic key masterkey is a shared secret between the payer and the payee communication devices PD, PD2. Furthermore, the first cryptographic key masterkey may be shared by any additional number of payer communication devices or payee communication devices in digital payment systems comprising a plurality of such devices. The first cryptographic key masterkey may be issued by a computerized certificate authority 50 included in the digital payment system 1, as seen in FIG. 1. The certificate authority 50 is a trusted third party responsible for issuing digital certificates that all devices of the system 1 can trust. To this end, the certificate authority 50 is configured to maintain a list of one or more first cryptographic keys masterkey being distributed for each TEE in the system 1, such as the TEEs 16, 26. The certificate authority 50 thus knows which the correct first cryptographic key masterkey is and can identify whether the first cryptographic key masterkey has been tampered with. The certificate authority 50 is further configured to maintain data and instructions used for onboarding and trusted application provisioning procedures for the computerized payer and payee account providers 60; 70; Issuer; Issuer 2. This is further explained with references to FIGS. 4 and 5 according to different embodiments.

In addition to the first cryptographic key masterkey, The TEEs 16; 26 further comprise a respective additional cryptographic key wallet_priv_key; wallet2_priv_key. Hereinafter, these additional cryptographic keys wallet_priv_key; wallet2_priv_key are referred to as a second cryptographic key wallet_priv_key comprised in the TEE 16 of the payer communication device PD, and a third cryptographic key wallet2_priv_key comprised in the TEE 26 of the payee communication device PD2. Accordingly, the TEE 16 of the payer communication device PD comprises the first cryptographic key masterkey as a shared secret and the second cryptographic key wallet_priv_key. Correspondingly, the TEE 26 of the payee communication device PD2 comprises the first cryptographic key masterkey as a shared secret and the third cryptographic key wallet2_priv_key.

In one or more embodiments, the second and third cryptographic keys wallet_priv_key, wallet2_priv_key are generated by means of a quantum-resistant PKI configuration for asymmetric data encryption, i.e. the second and third cryptographic keys are private cryptographic keys in a PKI (public key infrastructure)-based encryption scheme designed to be resistant against attacks by quantum computers. In preferable embodiments, quantum-resistant PKI configurations for asymmetric data encryption involve lattice-based cryptography such as the ring-LWE, NTRU, BLISS methods or multivariate cryptography such as the Rainbow-method as disclosed by Ding, J., Schmidt, D, “Rainbow, a new multivariable polynomial signature scheme” in June 2005. In alternative embodiments, quantum-resistant PKI configurations for asymmetric data encryption involve hash-based-cryptography such as Lamport signatures, Merkle signature scheme, XMSS or SPHINCS, code-based cryptography such as the McEliece or Niederreiter algorithms, supersingular elliptic curve isogeny or cryptography such as Diffie Hallman-key exchange with forward secrecy, or symmetric key with quantum resistance by the use of Kerberos-like symmetric key management.

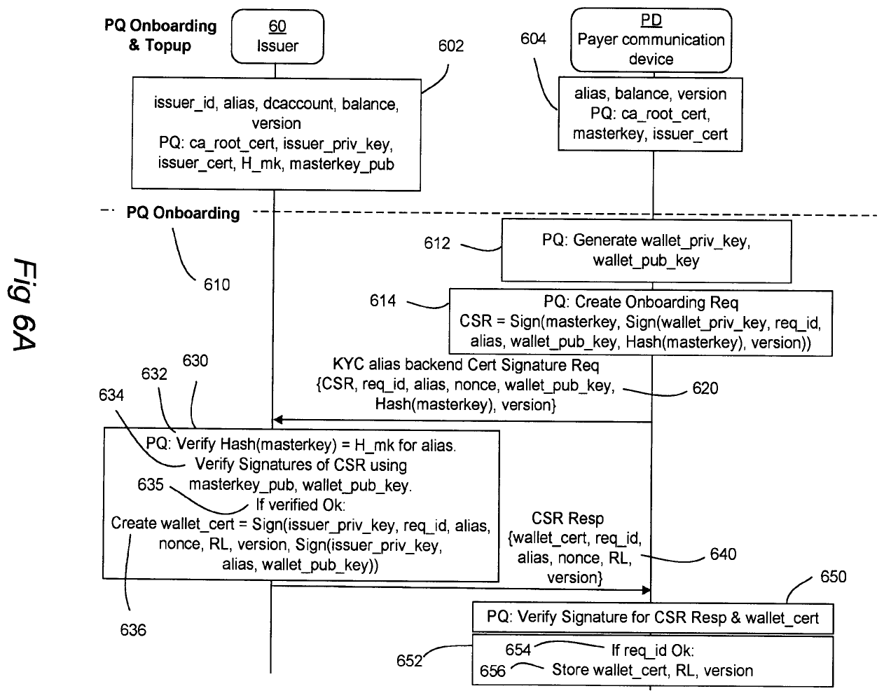

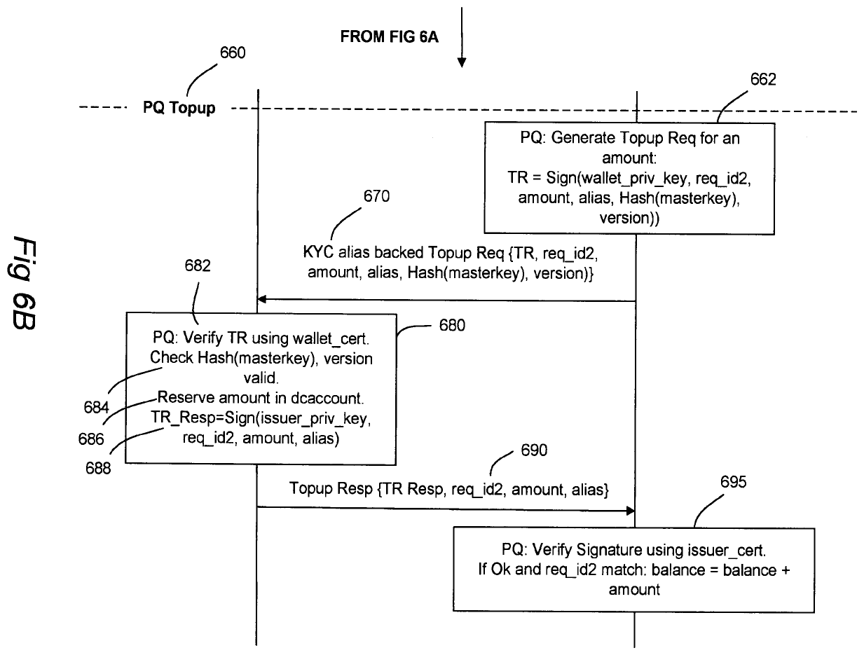

In the disclosed embodiment, each one of the TEEs 16, 26 further comprises a respective digital wallet DW, DW2, referred to as the payer digital wallet DW1 and the payee digital wallet DW2. The wallets have a respective local balance balance, balance2 representing a current monetary value available for offline payments. The local balances balance, balance2 are configured to be reduced for the payer communication device PD and increased for the payee communication device PD2, respectively, by a payment amount amount upon verification of a successful payment response 114. This will be further described according to one embodiment with reference to FIG. 7A. The local balances balance, balance2 correspond to a reservation of funds in the payer/payee accounts 62; 72 associated with the payer/payee PA; PA2 (possibly with an intermediate digital cash account, see below) and maintained at the computerized payer/payee account providers 60; 70. The reservation of funds may, for instance, be made with respect to a positive account balance or, alternatively, a line of credit of the payer/payee accounts 62; 72. An example of this is further shown and explained with reference to FIG. 6B.

Finally, the TEEs 16; 26 further comprise a respective public cryptographic key comprised in a respective digital certificate wallet_cert, wallet2_cert. The public cryptographic keys in wallet_cert, wallet2_cert are associated with the second cryptographic key wallet_priv_key or third cryptographic key wallet2_priv_key, respectively, and are used for verifying that a payment settlement request 122, 122′ has been duly signed by the payer communication device PD or payee communication device PD2.

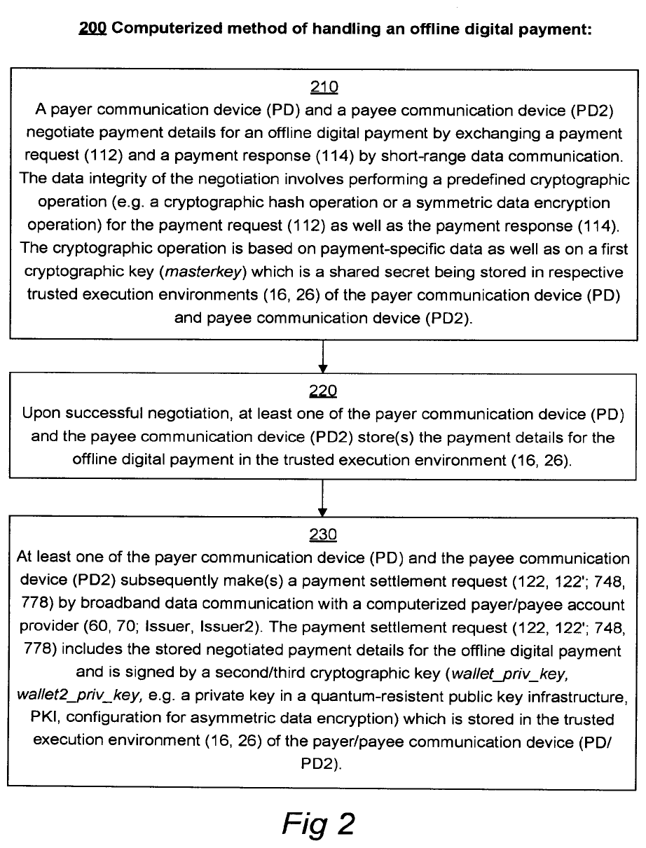

The negotiation 110, including a payment request 112 and a payment response 114, as well as the settlement 120, including payment settlement requests 122, 122′, will now be described in detail with reference to FIG. 2.

FIG. 2 illustrates a schematic flowchart diagram of a method 200 for handling an offline digital payment. The skilled person readily understands that the payer communication device PD, the payee communication device PD1, the computerized payer account provider 60; Issuer, and the computerized payee account provider 70; Issuer2 of the digital payment system 1 may be configured to perform the steps of the method 200 and its associated embodiments. Vice versa applies as well, i.e. the skilled person understands that the method 200 is capable of performing the functionalities of the payer communication device PD, the payee communication device PD1, the computerized payer account provider 60; Issuer, and the computerized payee account provider 70; Issuer2 of the digital payment system 1.

The method 200 comprises a first step of negotiating 210 payment details for an offline digital payment. The negotiating 210 is performed between the payer communication device PD and the payee communication device PD2. The negotiating 210 involves exchanging a payment request 112 and a payment response 114 by short-range data communication. This is also seen at the SRDC I/Fs 12, 22 of FIG. 1. The data integrity of the negotiation involves performing a predefined cryptographic operation, for instance the predefined cryptographic operation 30 as discussed with reference to FIG. 1 (e.g. cryptographic hash operation or symmetric data encryption operation), for the payment request 112 as well as the payment response 114. The cryptographic operation is based on payment-specific data as well as on a first cryptographic key, i.e. the first cryptographic key masterkey as described with reference to FIG. 1, being a shared secret stored in respective TEEs 16, 26 of the payer/payee communication devices PD, PD2.

The payment-specific data included in the payment request 112 may comprise a payment amount amount and an alias alias2 of a payee PA2 being an intended receiver of the offline digital payment. Correspondingly, the payment-specific data included in the payment response 114 may comprise said payment amount amount, said payee alias alias2 and an alias alias of a payer PA being an intended sender of the offline digital payment. Hence, the payment-specific data relates to data being exchanged during offline payment. The intended payer/payee PA, PA2 correspond to persons participating in said exchange of data during the offline payment. To this end, the payment specific data included in the payment request 112 may further comprise a payment request identifier payment_req_id. Correspondingly, the payment specific data included in the payment response 114 may comprise the payment amount amount, the payee alias alias2, the payment request identifier payment_req_id and an alias alias of a payer PA being the intended sender of the offline digital payment. The payment-specific data is further described with reference to FIG. 7A at steps 704 and 706.

The method 200 comprises a second step of storing 220 the payment details for the offline digital payment in the associated trusted execution environment (TEE) 16, 26. The storing 220 is performed by at least one of the payer communication device PD and the payee communication device PD2after successful negotiation of payment details between the two.

The method comprises a third step of making 230 a payment settlement request 122, 122′; 748, 778. The payment settlement request 122, 122; 748, 778′ is made by at least one of the payer communication device PD and the payee communication device PD1 by means of broadband data communication with a computerized payer account provider 60; Issuer or computerized payee account provider 70; Issuer2, respectively. The at least one payment settlement request 122, 122′; 748, 778 includes the stored negotiated payment details for the offline digital payment and is signed by a second cryptographic key or third cryptographic key, respectively by the devices PD, PD2, which is stored in the respective TEEs 16, 26. The second and third cryptographic keys may correspond to the keys wallet_priv_key, wallet2_priv_key that were described with reference to FIG. 1.

In one or more embodiments, the method 200 further involves, by a computerized certificate authority 50, provisioning the first cryptographic key masterkey to the payer and payee communication devices PD, PD2 via the computerized payer and payee account providers 60, 70; Issuer, Issuer2, respectively. The certificate authority 50 may provision the first cryptographic key masterkey as binary data of a trusted application asset, the first cryptographic key masterkey thereby being inaccessible to the computerized payer and payee account providers 60, 70; Issuer; Issuer2. This is further elaborated upon in the embodiment shown and explained with reference to FIG. 4.

The certificate authority 50 may further provide the computerized payer/payee account providers 60, 70; Issuer, Issuer2 with a result H_mk of performing the predefined cryptographic operation upon said first cryptographic key masterkey. Performing the cryptographic operation upon the cryptographic key masterkey simply refers to using the operation to conceal the contents of the key, for instance either by hashing the key or encrypting it by means of a symmetric encryption algorithm, as discussed with reference to FIG. 1. The respective computerized payer/payee account provider 60, 70; Issuer, Issuer2 may store the result H_mk for future reference, and use said stored result H_mk to verify a request received from the payer communication device PD or payee communication device PD2, respectively. The request comprises a corresponding result of the respective device PD, PD2 having performed the predefined cryptographic operation upon said first cryptographic key masterkey as stored locally in the TEEs 16, 26 of the respective device PD, PD2. Examples of different types of such requests are further shown and explained with references to FIGS. 6A (a payment service onboarding request 620) 6B (a local digital wallet topup request 670), and 7B (the payment settlement request 122, 122′; 748, 778), respectively.

Accordingly, the functionality of the certificate authority 50 as discussed above provides another layer of integrity since the first cryptographic key masterkey does not have to be revealed for either one of the computerized payer/payee account providers 60, 70; Issuer, Issuer2. A person or software with malicious intent would thus, in a worst case scenario upon either one of the computerized payer/payee account providers 60, 70; Issuer, Issuer2 being breached only get ahold of the result H_mk. Since this result H_mk is either hashed or protected by means of a symmetric data encryption operation, the shared secret being the first cryptographic key masterkey cannot be retrieved by said person or software with malicious intent. Moreover, even if H_mk is obtained by such a malicious person, he or she cannot make a valid offline digital payment using it.

In one or more embodiments, the method 200 further comprises, by at least one of the computerized payer account provider 60; Issuer and computerized payee account provider 70; Issuer2, receiving the payment settlement request 122, 122′; 748, 778. After receiving said payment settlement request 122, 122′; 748, 778, the method 200 involves verifying that it has been duly signed by the payer/payee communication device PD, PD2, respectively, by use of a public cryptography key, for instance corresponding to the public cryptography keys in wallet_cert, wallet2_cert as described with reference to FIG. 1. The method 200 may further involve triggering settlement of the offline digital payment upon successful verification of the signature of the payment settlement request 122, 122′; 748, 778. The receiving and verifying of the request, as well as the triggering of the settlement, is further shown and explained with reference to FIG. 7B according to one embodiment.

In one or more embodiments, the method 200 further comprises verifying the payment settlement request 122, 122′; 748, 778 based on the public cryptographic key in wallet_cert or wallet2_cert. These embodiments involve, by at least one of the payer/payee communication devices PD, PD2, performing, in the TEE 16, 26, said predefined cryptographic operation upon said first cryptographic key masterkey. Moreover, result data representing a result of said performing is included in the payment settlement request 122, 122′; 748, 778. These embodiments further involve, by at least one of the computerized payer/payee account providers 60, 70; Issuer, Issuer2, receiving the payment settlement request 122, 122′; 748, 778 and performing a two-step verification procedure of the payment settlement request 122, 122′; 748, 778. The two-step procedure involves a first step of verifying that the payment settlement request 122, 122′; 748, 778 has been duly signed by the payer/payee communication device PD, PD2, respectively, by use of the public cryptography key in wallet_cert, wallet2_cert being associated with a respective second or third cryptographic key wallet_priv_key, wallet2_priv_key in a quantum-resistant public key infrastructure, PKI, configuration for asymmetric data encryption. The two-step procedure further involves a second step of verifying that the stored result H_mk of performing the predefined cryptographic operation upon said first cryptographic key masterkey as provided from the certificate authority 50 matches the result data included in the payment settlement request 122, 122′; 748, 778. Finally, these embodiments involve triggering settlement of the offline digital payment upon successful outcome of both steps of verification of the payment settlement request 122, 122′; 748, 778. The two-step verification of the payment settlement request 122, 122′; 748, 778 as discussed herein provides additional data integrity. The verification of the payment settlement request 122, 122′; 748, 778 according to the above-described two-step verification is further shown and explained with reference to FIG. 7B according to one embodiment. In one or more embodiments, the method 200 further comprises version handling of the first cryptographic key masterkey. The payee communication device PD2 indicates, in the payment request 112, a version of the first cryptographic key masterkey comprised in its TEE 26. Moreover, the payer communication device PD checks that the version of the first cryptographic key masterkey indicated in the payment request 112 is the same as or compatible with a version of the first cryptographic key masterkey comprised in its own TEE 16. By handling versions of the first cryptographic key masterkey, potential breaches of the first cryptographic key masterkey can be taken care of by confirming that the version indicated in the request 112 corresponds to or is at least compatible with the version in the TEE 16, 26 of the associated device PD, PD2. Handling versions of the first cryptographic key masterkey is further seen and explained in the exemplary embodiments of FIGS. 4-7.

In one or more embodiment, the method 200 further comprises performing and handling settlement requests 122, 122′; 748, 778 made from both the payer and the payee devices PD, PD2. These embodiments involve, by the payer device PD upon successfully verifying the payment request 112, storing the payment-specific data included in the payment request 114 as negotiated payment details for the offline digital payment in its TEE 16. The payer device PD subsequently makes a payment settlement request 122, 748 by means of broadband data communication, e.g. via the WAN I/F 11 as discussed with reference to FIG. 1, with the computerized payer account provider 60; Issuer. The payment settlement request 122, 748 includes the stored negotiated payment details for the offline digital payment and is signed by the second cryptographic key wallet_priv_key. Moreover, these embodiments further involve, by the payee device PD2 upon successfully verifying the payment response 114, storing the payment-specific data included in the payment response 114 as negotiated payment details for the offline digital payment in its TEE 26. The payee device PD2 subsequently makes a payment settlement request 122′, 778 by means of broadband data communication, e.g. via the WAN I/F 21 as discussed with reference to FIG. 1, with the computerized payee account provider 70; Issuer2. The payment settlement request 122′; 778 includes the stored negotiated payment details for the offline digital payment and is signed by the third cryptographic key wallet2_priv_key.

In some embodiments, the payment-specific data included in the payment response 114 comprises a payment identifier payment_id, wherein the method 200 further comprises, by each of the payer/payee communication devices PD, PD2 upon successful verification of the payment request 112 and the payment response 114, respectively, storing the negotiated payment details for the offline digital payment including said payment identifier payment_id in the respective TEE 16, 26. Moreover, the payment identifier payment_id is included in the respective payment settlement request 122, 122′; 748, 778. A consequence of this is that double settlement of the offline digital payment is effectively prevented. Dual payment settlement requests 122, 122′; 748, 778 are further illustrated and described with reference to FIG. 7B, as well as indicated in FIG. 1.

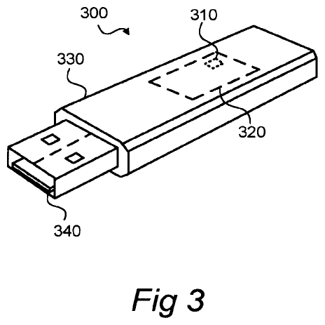

FIG. 3 is a schematic illustration of a computer-readable medium 300 in one exemplary embodiment, capable of storing a computer program product 310. The computer-readable medium 300 in the disclosed embodiment is a portable memory device, such as a Universal Serial Bus (USB) stick. The computer-readable medium 300 may however be embodied in various other ways instead, as is well-known per se to the skilled person. The portable memory device 300 comprises a housing 330 having an interface, such as a connector 340, and a memory chip 320. In the disclosed embodiment, the memory chip 320 is a flash memory, i.e. a non-volatile data storage that can be electrically erased and re-programmed. The memory chip 320 stores the computer program product 310 which is programmed with computer program code (instructions) that when loaded into a processing device, such as a CPU, will perform any of the functionalities listed in the next paragraph. The processing device may, for instance, be the aforementioned processing devices of the controllers 13; 23 as described with reference to FIG. 1. The portable memory device 300 is arranged to be connected to and read by a reading device for loading the instructions into the processing device. It should be noted that a computer-readable medium can also be other media such as compact discs, digital video discs, hard drives or other memory technologies commonly used. The computer program code (instructions) can also be downloaded from the computer-readable medium via a wireless interface to be loaded into the processing device.

In one embodiment, therefore, the computer-readable medium 300/computer program product 310 comprises computer program code for performing the functionality of the payer communication device PD in the method 200 as described herein when the computer program code is executed by the processing device. In another embodiment, the computer-readable medium 300/computer program product 310 comprises computer program code for performing the functionality of the payee communication device PD2 in the method 200 as described herein when the computer program code is executed by the processing device. In still other embodiments, the computer-readable medium 300/computer program product 310 comprises computer program code for performing the functionality of the computerized payer/payee account providers 60; 70, Issuer; Issuer2 in the method 200 as described herein when the computer program code is executed by the processing device.

FIG. 4 illustrates onboarding activities 410 for the computerized payer account provider 60 according one embodiment. In the terminology normally used for EMV (Europay, Mastercard and VISA) card payments, the computerized payer account provider 60 can be seen as a payment issuer. Hence, the short term “issuer” is indicated for the computerized payer account provider 60 in FIG. 4. The onboarding procedure starts with the payer account provider 60 generating a private/public PKI key pair issuer_priv_key, issuer_pub_key at 412. At 414, the payer account provider 60 creates a certificate signing request, CSR, by signing, with the private key issuer_priv_key, a dataset which comprises a request id req_id, an identifier issuer_id of the payer account provider 60, and the public key issuer_pub_key. The payer account provider 60 makes a secure Transport Layer Security, TLS, login at the computerized certificate authority 50, using the created CSR.

Upon login from the payer account provider 60, the certificate authority 50 performs an onboarding procedure 430 which involves the following. At 432, the CSR from the payer account provider 60 is verified using the public key issuer_pub_key included therein. If the verification is found to be successful at 433, a digital certificate is created at 434. This involves performing 435 the aforementioned predefined crypto-graphic operation 30, being in this embodiment a cryptographic hash operation, upon a cryptographic key masterkey (which will later on be provisioned to the payer communication device PD and the payee communication device PD2 as a shared secret, cf. FIG. 5). This results in a hash H_mk. The certificate authority 50 then generates 436 the digital certificate issuer_cert for the payer account provider 60 by signing a dataset with a private key priv_root_key which has a corresponding public key in a digital root certificate ca_root_cert (see 404). The dataset signed at 434 comprises req_id and issuer_id from the CSR, and in addition a nonce, i.e. a one-time arbitrary cryptographic value, a version of masterkey, and the hash H_mk of masterkey. The version is identified from a data structure kept by the certificate authority 50 (see 405; the data structure also comprises a public key masterkey_pub corresponding to masterkey). The certificate authority 50 records 438 the version and the hash H_mk for the particular issuer_id of the payer account provider 60, for later reference.

At 440, the certificate authority 50 sends a CSR response to the payer account provider 60. The CSR response includes the generated issuer_cert, as well as req_id, issuer_id, nonce, version, H_mk and masterkey_pub. At 450, the payer account provider 60 verifies issuer_cert by using the public key of the digital root certificate ca_root_cert (the payer account provider 60 is assumed to already have access to ca_root_cert as seen at 402; if not, ca_root_cert can be included in the CSR response). Upon successful verification in step 450, a step 452 follows in which the payer account provider 60 checks 454 that req_id in the CSR response is the one sent at 420 in the CSR. If ok, at 456 the payer account provider 60 stores issuer_priv_key (as generated at 412) and the digital certificate issuer_cert (as provided in the CSR response), and moreover the version of masterkey and the hash H_mk—but, notably, not masterkey itself, since this is not made available to the payer account provider 60 (the benefit thereof has already been explained above). Hence, the payer account provider 60 has been onboarded and enabled for performing its tasks as previously described. The payee account provider 70 can be onboarded in the corresponding manner, even though not shown in FIG. 5.

FIG. 5 illustrates activities for provisioning a trusted application TA in one embodiment. The TA is intended for execution in the trusted execution environment TEE of the payer account provider 60 and payee account provider 70 to perform the negotiation and settlement functionalities 110 (including 112 and 114), 120 (including 122, 122′) as described above with reference to FIG. 1, but it is provisioned through the payer account provider 60 in the manner shown in FIG. 5, and correspondingly through the payee account provider 70 even if not shown.

In more detail, the provisioning of the trusted application TA to the payer account provider 60 involves the following. At 512 a TA provisioning request is received from an operating system layer or an application layer above the TEE layer in the payer communication device PD. In response, at 514 the payer account provider 60 creates a provisioning request by signing the following data with the private key of issuer_cert (as obtained upon onboarding of the payer account provider 60 in FIG. 4): an application id app_id, a request id req_id, the identifier issuer_id of the payer account provider 60, and the hash H_mk of masterkey (also obtained upon onboarding in FIG. 4). As seen at 520, the payer account provider 60 makes a TLS login at the computerized certificate authority 50, using the created provisioning request and including also its public key issuer_pub_key.

Upon login from the payer account provider 60, the certificate authority 50 performs a TA provisioning procedure 530 which involves the following. At 532, the provisioning request from the payer account provider 60 is verified using issuer_pub_key as provided at login. If the verification is found to be successful at 533, the certificate authority 50 identifies at 534-535 which version of masterkey to use for the particular payer account provider 60, as represented by issuer_id.

Then commences a process 537 for prebuilding a trusted application asset TA_asset for the trusted application TA. Trusted application asset TA_asset includes masterkey and its version, app_id, issuer_cert and ca_root_cert, in binary data form (masterkey thereby being inaccessible to the receiving payer account provider 60). The certificate authority 50 then creates a provisioning response at 538, signed by priv_root_key (cf. 504) and including the TA_asset, req_id, app_id, issuer_id and the hash H_mk of masterkey. The certificate authority 50 sends the provisioning response to the payer account provider 60 at 540.

Upon receipt at 550, the payer account provider 60 verifies at 552 the signature of the provisioning response by using the public key of the digital root certificate ca_root_cert (available to the payer account provider 60 at 502). If the verification is successful, see 554, a step 556 follows in which the payer account provider 60 builds an application (or updates it if already existing) to include the received TA_asset in binary form, with masterkey and its version, issuer_cert and ca_root_cert included therein (cf. step 537 above). The application thus built or updated can be distributed to the payer communication device PD in step 558.

Corresponding functionality can be performed for provisioning a trusted application asset for the payee communication device PD2 through the payee account provider 70, even though not shown in FIG. 5.

FIG. 6A illustrates an embodiment of activities 610 for onboarding of the payer communication device PD, and more specifically the payer digital wallet DW in the trusted execution environment TEE of the payer communication device PD, with respect to the payer account provider 60. Corresponding functionality can be performed for onboarding of the payee communication device PD2 (the payee digital wallet DW2) with respect to the payee communication device 70, even though not shown in FIG. 6A. As seen at 612, the payer communication device PD generates a private/public PKI key pair wallet_priv_key, wallet_pub_key, as previously referred to with reference to FIG. 1.

At 614, the payer communication device PD creates a wallet onboarding request, CSR, by signing, with the masterkey, a dataset which in turn comprises a dataset comprised by a request id req_id, the alias of the payer PA associated with the payer communication device PD, wallet_pub_key, and a hash of masterkey as well as its version, this latter dataset being signed with wallet_priv_key. The thus created and signed wallet onboarding request CSR is sent to the payer account provider 60 at 620 and can be seen as a request for onboarding of a local wallet-based payment service offered by the payer account provider 60.

In step 630, the payer account provider 60 processes the received wallet onboarding request CSR as follows. First, at 632, it is verified that the hash of masterkey as included in the CSR matches the previously registered H_mk (cf. step 456 in FIG. 4). Then, at 634, the two-level signatures of the CSR are verified using the public keys masterkey_pub and wallet_pub_key, respectively. If the verifications are successful at 635, the payer account provider 60 creates the aforementioned digital certificate wallet_cert for the payer digital wallet DW by signing, with issuer_priv_key, a dataset that comprises req_id, the alias of PA, a nonce, risk limits RL, the version of masterkey and a dataset which, in turn, comprises alias of PA and wallet_pub_key, signed with issuer_priv_key. The risk limits RL may, for instance, define one or more of the following: a maximum payment amount for each offline digital payment, a maximum number of offline digital payments performable during a certain time (such as a day, week, month, etc., a definition of payment receivers (including payee PA2) that the payer PA is allowed to make offline digital payments to, and a definition of payment receivers that the payer PA is not allowed to make offline digital payments to.

The payer account provider 60 then sends a wallet onboarding response 640 to the payer communication device PD. The wallet onboarding response 640 comprises the wallet certificate wallet_cert and, in addition, req_id, alias, nonce, RL and version. Upon receipt of the wallet onboarding response 640, the payer communication device PD verifies in step 650 the signature of the wallet onboarding response as such, as well as the wallet certificate wallet_cert using issuer_pub_key. Upon successful verification in step 650, the payer communication device PD checks that req_id in the wallet onboarding response is the one sent at 614 in the wallet onboarding request CSR. If ok, at 656, the payer communication device PD stores wallet_cert, RL and version. This completes the onboarding of the payer digital wallet DW in the payer communication device PD with respect to the payer account provider 60.

In the disclosed embodiment, the payer digital wallet DW is associated with a digital cash account deaccount having a balance which may be used for increasing the balance of the payer digital wallet DW in the payer communication device PD by way of a topup procedure. This is further described below with reference to FIG. 6B. In some embodiments, deaccount may be identical to the aforementioned payer account 62 (cf. FIG. 1). In other embodiments, deaccount may be a separate account that the payer PA may replenish with funds from the payer account 62 (being an ordinary bank account).

As can be seen in FIG. 6B, the topup procedure 660 for the payer digital wallet DW in the payer communication device PD involves the following. At 662, the payer communication device PD generates a wallet topup request TR for a certain topup amount (denoted amount in the drawing) by signing, with the private key wallet_priv_key generated at 612 in FIG. 6A, a dataset which comprises the following: a topup request identifier req_id2, the requested topup amount, the alias of the payer PA, a hash of masterkey, and the version of masterkey. The topup request TR is communicated to the payer account provider 60 at 670.

The payer account provider 60 processes the topup request TR at 680 in the following manner. First, at 682, the signature of the topup request TR is verified using the public key in wallet_cert (as created at 636 in FIG. 6A). Then, at 684, it is verified that the hash of masterkey as included in the topup request TR matches the previously registered H_mk (cf. step 456 in FIG. 4). A check is also made with respect to the version of masterkey.

Upon successful verification, the payer account provider 60 does the following. At 686, a reservation corresponding to the requested topup amount is made in dcaccount, provided that the balance of dcaccount can cover the requested topup amount. If not, a lesser topup amount may be granted. At 688, a topup response is then generated by signing, with issuer_priv_key, a dataset which comprises the topup request identifier req_id2, the requested or granted topup amount and the alias of the payer PA. The topup response is sent to the payer communication device PD in step 690.

The payer communication device PD processes the received topup response as follows in step 695. The signature is verified using the public key of issuer_cert. A check is made that req_id2 in the received topup response matches the req_id2 in the topup request TR. If successful, the balance of the payer digital wallet DW in increased by the topup amount.

FIG. 7A illustrates activities 710 for performing an offline digital payment according to one embodiment, being one possible (but, of course, not the only) implementation of the payment details negotiation 110 in FIG. 1, and steps 210 and 220 in FIG. 2. In step 702, the payee communication device PD2 generates a payment request PR. A dataset TBH with payment-specific data comprises a payment request identifier payment_req_id, the requested payment amount (denoted amount in the drawing), the alias, alias2, of the payee PA2 associated with the payee communication device PD2, the version, version2, of the masterkey as previously provided to the TEE 26 of the payee communication device PD2 (cf. 558 in FIG. 5), a timestamp and a nonce. The hash H of TBH combined with masterkey is calculated. The payment request PR is generated to include H as well as TBH.

In step 704, a communication link for short-range data communication is established between the payee communication device PD2 and the payer communication device PD. Using this communication link, the payment request PR is communicated from PD2 to PD. This is an implementation of step 112 in FIG. 1.

The payer communication device PD processes the received payment request PR as follows at 710. First, as seen at 711, the payer communication device PD checks that version2 of masterkey is supported. Then, at 712, it is verified that the hash of TBH (as included in clear text in the payment request PR) combined with masterkey (being securely stored in the TEE 16 of the payer communication device PD) matches the hash H in the received payment request PR.

Further checks are made at 713 that the requested payment amount meets the risk limits RL that were previously admitted to the payer communication device PD (payer PA) during the wallet onboarding procedure in FIG. 6A, and that the requested payment amount does not exceed the current balance of the payer digital wallet DW.

If everything is found ok at 714, the payer communication device PD proceeds to generate an offline digital payment P. This involves forming a dataset comprising the payment-specific data TBH from the payment request PR, a payment identifier payment_id, the alias of the payer PA (denoted alias in the drawing), a nonce nonce2 and masterkey, and calculating a hash P_H of this dataset. Negotiated payment details P for the offline digital payment are then generated as a dataset comprising P_H, payment_id alias and TBH, and stored at 716 together with masterkey and version. This corresponds to step 220 in FIG. 2 (for PD).

A payment response 720 which includes P_H, payment_id and alias is sent from the payer communication device PD to the payee communication device PD2 in step 720. This corresponds to step 114 in FIG. 1. The payee communication device PD2 processes the received payment response as seen at 730. First, the negotiated payment details P are recreated at 732 by adding TBH to the data in the payment response. The recreated negotiated payment details/are verified at 734 by checking that the hash of TBH, payment_id, alias, nonce2 and masterkey indeed matches P_H from the payment response 720.

Upon successful verification, the balance of the payee digital wallet DW2, balance2, is increased by amount. Finally, the payee communication device PD2 stores the negotiated payment details P for the offline digital payment at 738 together with masterkey and version2. This corresponds to step 220 in FIG. 2 (for PD2).

FIG. 7B illustrates activities 740 for requesting settlement of the offline digital payment made in FIG. 7A according to one embodiment. In step 745, the payer communication device PD handles the stored offline digital payment (or, in alternative embodiments which allow buffering of multiple digital payments, each stored offline digital payment) as follows. A payment settlement request is generated by signing, with wallet_priv_key, a dataset comprising the stored negotiated payment details P, the hash H_mk of masterkey and a nonce nonce4. The signed payment settlement request is sent at 748 (cf. 122 in FIG. 1) to the payer account provider 60.

The payer account provider 60 processes the received signed payment settlement request as follows in step 750. The signature S of the payment settlement request is verified using the public key of wallet_cert. A check is made that H_mk in the payment settlement request matches H_mk as previously provided to the payer account provider 60. The payment is logged at 756, and settlement is triggered at 758 (cf. 120 in FIG. 1). Then, a payment settlement response is signed with issuer_priv_key and sent at 760 by the payer account provider 60 to the payer communication device PD. Upon receipt 762, the payer communication device PD checks 764 the signature using the public key of issuer_cert. If ok, the payer communication device PD erases the stored negotiated payment details P from the storage in the TEE.

At steps 775, 778, 780, 782, 784, 786, 788, 790, 792, 794 and 796, corresponding activities for requesting settlement of the offline digital payment by the payee communication device PD2 are shown.

The invention has mainly been described above with reference to a few embodiments. However, as is readily appreciated by a person skilled in the art, other embodiments than the ones disclosed above are equally possible within the scope of the invention, as defined by the appended patent claims.

1. A digital payment system, comprising:
a payer communication device and a payee communication device, each having a short-range data communication interface, a broadband data communication interface and a trusted execution environment enabled for performing a predefined cryptographic operation;
a computerized payer account provider being a cloud-based computing resource capable of broadband data communication; and
a computerized payee account provider being a cloud-based computing resource capable of broadband data communication,
wherein the trusted execution environment of the payer communication device comprises a first cryptographic key being a shared secret between the payer and payee communication devices, and a second cryptographic key,
wherein the trusted execution environment of the payee communication device comprises said first cryptographic key being the shared secret between the payer and payee communication devices, and a third cryptographic key,
wherein the payer communication device and the payee communication device are configured to negotiate payment details for an offline digital payment by exchanging a payment request and a payment response by short-range data communication,
wherein the negotiation involves the payer communication device: verifying the payment request by performing the predefined cryptographic operation based on payment-specific data included in the payment request as well as on the first cryptographic key and comparing with cryptographic data also included in the payment request and being the result of the payee communication device having performed the same predefined cryptographic operation based on said payment-specific data as well as on said first cryptographic key,
wherein the negotiation further involves the payee communication device verifying the payment response by performing the predefined cryptographic operation based on payment-specific data included in the payment response as well as on the first cryptographic key and comparing with cryptographic data also included in the payment response and being the result of the payer communication device having performed the same predefined cryptographic operation based on said payment-specific data as well as on said first cryptographic key, and
wherein at least one of the payer communication device and the payee communication device is configured to:
upon successful verification of the payment request or the payment response, respectively, store the payment-specific data included in the payment response as negotiated payment details for the offline digital payment in the trusted execution environment, and
subsequently make a payment settlement request by broadband data communication with the computerized payer account provider or the computerized payee account provider, respectively, the payment settlement request including the stored negotiated payment details for the offline digital payment and being signed by the second cryptographic key or third cryptographic key, respectively.

2. The digital payment system as defined in claim 1, wherein the predefined cryptographic operation is one of: a cryptographic hash operation, and a symmetric data encryption operation.

3. (canceled)

4. The digital payment system as defined in claim 1, further comprising a computerized certificate authority configured for provisioning the first cryptographic key to the payer and payee communication devices via the computerized payer and payee account providers, respectively, as binary data of a trusted application asset, the first cryptographic key thereby being inaccessible to the computerized payer and payee account providers.

5. The digital payment system as defined in claim 4,
wherein the computerized certificate authority is further configured for providing the computerized payer and payee account providers with a result of performing the predefined cryptographic operation upon said first cryptographic key, and
wherein at least one of the computerized payer account provider and computerized payee account provider is configured for:
storing said result for future reference; and
using said stored result to verify a request received from the payer communication device or payee communication device, respectively, said request comprising a corresponding result of the respective device having performed the predefined cryptographic operation upon said first cryptographic key as stored locally in the trusted execution environment of the respective device, the request being one of:
a payment service onboarding request,
a local digital wallet topup request, and
said payment settlement request.

6. The digital payment system as defined in claim 1, wherein at least one of the computerized payer account provider and computerized payee account provider is configured for:
receiving the payment settlement request;
verifying that the payment settlement request has been duly signed by the payer communication device or payee communication device, respectively, by use of a public cryptographic key being associated with the second cryptographic key or third cryptographic key, respectively; and
triggering settlement of the offline digital payment upon successful verification of the signature of the payment settlement request.

7. The digital payment system as defined in claim 5,
wherein said at least one of the payer communication device and the payee communication device is configured to include in the payment settlement request result data representing the result of performing, in the trusted execution environment, said predefined cryptographic operation upon said first cryptographic key, and
wherein at least one of the computerized payer account provider and computerized payee account provider is configured for:
receiving the payment settlement request;
performing two steps of verification of the payment settlement request by:
i) verifying that the payment settlement request has been duly signed by the payer communication device or the payee communication device, respectively, by use of a public cryptographic key being associated with the second cryptographic key or third cryptographic key, respectively, and
ii) verifying that said stored result of performing the predefined cryptographic operation upon said first cryptographic key as provided from the computerized certificate authority matches the result data included in the payment settlement request; and
triggering settlement of the offline digital payment upon successful outcome of both steps of verification of the payment settlement request.

8. The digital payment system as defined in claim 6, wherein the second cryptographic key or third cryptographic key complies with a quantum-resistant public key infrastructure, PKI, configuration for asymmetric data encryption being based on one of the following: lattice-based cryptography, multivariate cryptography, hash-based-cryptography, code-based cryptography, supersingular elliptic curve isogeny, and Diffie Hallman-key exchange with forward secrecy.

9. The digital payment system as defined in claim 1, wherein the payment-specific data included in the payment request comprises a payment amount and an alias of a payee being an intended receiver of the offline digital payment, and wherein the payment-specific data included in the payment response comprises said payment amount, said payee alias and an alias of a payer being an intended sender of the offline digital payment.

10. The digital payment system as defined in claim 9, wherein the trusted execution environment of the payer communication device comprises a payer digital wallet having a local balance representing a current monetary value available for offline payments, and wherein the payer communication device is configured, upon successful verification of the payment request, to reduce the local balance of the payer digital wallet by the payment amount.

11. The digital payment system as defined in claim 10, wherein the trusted execution environment of the payee communication device comprises a payee digital wallet having a local balance representing a current monetary value available for offline payments, and wherein the payee communication device is configured, upon successful verification of the payment response, to increase the local balance of the payee digital wallet by the payment amount.

12. The digital payment system as defined in any of claim 9, wherein the payment-specific data included in the payment request further comprises a payment request identifier, and wherein the payment-specific data included in the payment response comprises said payment amount, said payee alias, said payment request identifier and an alias of a payer being an intended sender of the offline digital payment.

13. The digital payment system as defined in claim 11, wherein the trusted execution environment of the payee communication device comprises a payee digital wallet having a local balance representing a current monetary value available for offline payments, and wherein the payee communication device is configured, upon successful verification of the payment response, to increase the local balance of the payee digital wallet by the payment amount, and wherein the payee communication device is configured to check that the payment request identifier comprised in the payment-specific data included in the payment response matches the payment request identifier comprised in the payment-specific data included in the payment request as a further requisite for increasing the local balance of the payee digital wallet by the payment amount.

14. The digital payment system as defined in claim 1,
wherein the payee communication device is configured to indicate, in the payment request, a version of the first cryptographic key comprised in its trusted execution environment, and
wherein the payer communication device is configured to check that the version of the first cryptographic key indicated in the payment request is the same as or compatible with a version of the first cryptographic key comprised in its own trusted execution environment.

15. The digital payment system as defined in claim 1,
wherein the payer communication device is configured, upon successful verification of the payment request, to store the payment-specific data included in the payment response as negotiated payment details for the offline digital payment in the trusted execution environment, and subsequently make a payment settlement request by broadband data communication with the computerized payer account provider, the payment settlement request including the stored negotiated payment details for the offline digital payment and being signed by the second cryptographic key, and
wherein the payee communication device is configured, upon successful verification of the payment response, to store the payment-specific data included in the payment response as negotiated payment details for the offline digital payment in the trusted execution environment, and subsequently make a payment settlement request by broadband data communication with the computerized payee account provider, the payment settlement request including the stored negotiated payment details for the offline digital payment and being signed by the third cryptographic key.

16. The digital payment system as defined in claim 15,
wherein the payment-specific data included in the payment response comprises a payment identifier,
wherein each of the payer communication device and the payee communication device is configured, upon successful verification of the payment request and the payment response, respectively, to store the negotiated payment details for the offline digital payment including said payment identifier in the trusted execution environment, and
wherein each of the payer communication device and the payee communication device is configured to include said payment identifier in the respective payment settlement request, thereby preventing double settlement of the offline digital payment.

17. A communication device for use in a digital payment system, the communication device comprising:
a short-range data communication interface;
a broadband data communication interface; and
a trusted execution environment enabled for performing a predefined cryptographic operation,
wherein the trusted execution environment comprises a first cryptographic key being a shared secret, and an additional cryptographic key,
the communication device being configured to act either for a payer or for a payee to negotiate payment details for an offline digital payment by exchanging a payment request and a payment response by short-range data communication with another communication device,
wherein the negotiation involves, when the communication device acts for the payer, verifying the payment request by performing the predefined cryptographic operation based on payment-specific data included in the payment request as well as on the first cryptographic key and comparing with cryptographic data also included in the payment request and being the result of said another communication device having performed the same predefined cryptographic operation based on said payment-specific data as well as on said first cryptographic key,
wherein the negotiation involves, when the communication device acts for the payee, verifying the payment response by performing the predefined cryptographic operation based on payment-specific data included in the payment response as well as on the first cryptographic key and comparing with cryptographic data also included in the payment response and being the result of the payer communication device having performed the same predefined cryptographic operation based on said payment-specific data as well as on said first cryptographic key,
the communication device being configured, upon successful verification of the payment request or the payment response, respectively, to store the payment-specific data included in the payment response as negotiated payment details for the offline digital payment in the trusted execution environment, and
the communication device being configured to subsequently send a payment settlement request by broadband data communication, the payment settlement request including the stored negotiated payment details for the offline digital payment and being signed by the additional cryptographic key.

18. (canceled)

19. (canceled)

20. A computing resource configured to perform the functionality of the computerized payer account provider in the digital payment system as defined by claim 1.

21. A computing resource configured to perform the functionality of the computerized payee account provider in the digital payment system as defined by claim 1.

22. A computerized method of handling an offline digital payment, comprising:
a payer communication device and a payee communication device negotiating payment details for an offline digital payment by exchanging a payment request and a payment response by short-range data communication, wherein the negotiation involves performing a predefined cryptographic operation for the payment request as well as the payment response, the cryptographic operation being based on payment-specific data as well as on a first cryptographic key which is a shared secret being stored in respective trusted execution environments of the payer communication device and payee communication device;
at least one of the payer communication device and the payee communication device, upon successful negotiation, storing the payment details for the offline digital payment in the trusted execution environment; and
said at least one of the payer communication device and the payee communication device subsequently making a payment settlement request by broadband data communication with a computerized payer account provider or computerized payee account provider, respectively, the payment settlement request including the stored negotiated payment details for the offline digital payment and being signed by a second cryptographic key or third cryptographic key, respectively, which is stored in the trusted execution environment of the payer communication device or payee communication device, respectively.

23. The computerized method as defined in claim 22, the predefined cryptographic operation being a cryptographic hash operation or a symmetric data encryption operation.

24. The computerized method as defined in claim 22, the second cryptographic key or third cryptographic key being a private key in a quantum-resistant public key infrastructure, PKI, configuration for asymmetric data encryption being based on one of the following: lattice-based cryptography, multivariate cryptography, hash-based-cryptography, code-based cryptography, supersingular elliptic curve isogeny, and Diffie Hallman-key exchange with forward secrecy.

25. The computerized method as defined in claim 22, further comprising, by a computerized certificate authority, provisioning the first cryptographic key to the payer and payee communication devices via the computerized payer and payee account providers, respectively, as binary data of a trusted application asset, the first cryptographic key thereby being inaccessible to the computerized payer and payee account providers.

26. The computerized method as defined in claim 25, further comprising
by the computerized certificate authority:
providing the computerized payer and payee account providers with a result of performing the predefined cryptographic operation upon said first cryptographic key, and
by at least one of the computerized payer account provider and computerized payee account provider:
storing said result for future reference; and
using said stored result to verify a request received from the payer communication device or payee communication device, respectively, said request comprising a corresponding result of the respective device having performed the predefined cryptographic operation upon said first cryptographic key as stored locally in the trusted execution environment of the respective device, the request being one of:
a payment service onboarding request,
a local digital wallet topup request, and
said payment settlement request.

27. The computerized method as defined in claim 22, further comprising, by at least one of the computerized payer account provider and computerized payee account provider:
receiving the payment settlement request;
verifying that the payment settlement request has been duly signed by the payer communication device or payee communication device, respectively, by use of a public cryptographic key being associated with the second cryptographic key or third cryptographic key, respectively; and
triggering settlement of the offline digital payment upon successful verification of the signature of the payment settlement request.

28. The computerized method as defined in claim 22, further comprising
by said at least one of the payer communication device and the payee communication device:
performing, in the trusted execution environment, said predefined cryptographic operation upon said first cryptographic key, and
including result data, representing a result of said performing, in the payment settlement request, and
by at least one of the computerized payer account provider and computerized payee account provider:
receiving the payment settlement request;
performing two steps of verification of the payment settlement request by:
i) verifying that the payment settlement request has been duly signed by the payer communication device or the payee communication device, respectively, by use of a public cryptographic key being associated with the second cryptographic key or third cryptographic key, respectively, and
ii) verifying that said stored result of performing the predefined cryptographic operation upon said first cryptographic key as provided from the computerized certificate authority matches the result data included in the payment settlement request; and
triggering settlement of the offline digital payment upon successful outcome of both steps of verification of the payment settlement request.

29. The computerized method as defined in claim 27, wherein the second cryptographic key or third cryptographic key complies with a quantum-resistant public key infrastructure, PKI, configuration for asymmetric data encryption being based on one of the following: lattice-based cryptography, multivariate cryptography, hash-based-cryptography, code-based cryptography, supersingular elliptic curve isogeny, and Diffie Hallman-key exchange with forward secrecy.

30. The computerized method as defined in claim 22, wherein the payment-specific data included in the payment request comprises a payment amount and an alias of a payee being an intended receiver of the offline digital payment, and wherein the payment-specific data included in the payment response comprises said payment amount, said payee alias and an alias of a payer being an intended sender of the offline digital payment.

31. The computerized method as defined in claim 30, the trusted execution environment of the payer communication device comprising a payer digital wallet having a local balance representing a current monetary value available for offline payments, wherein the method comprises, by the payer communication device upon successful verification of the payment request, reducing the local balance of the payer digital wallet by the payment amount.

32. The computerized method as defined in claim 31, the trusted execution environment of the payee communication device comprising a payee digital wallet having a local balance representing a current monetary value available for offline payments, wherein the method comprises, by the payee communication device upon successful verification of the payment response, increasing the local balance of the payee digital wallet by the payment.

33. The computerized method as defined in claim 30, wherein the payment-specific data included in the payment request further comprises a payment request identifier, and wherein the payment-specific data included in the payment response comprises said payment amount, said payee alias, said payment request identifier and an alias of a payer being an intended sender of the offline digital payment.

34. The computerized method as defined in claims 32, wherein the payment-specific data included in the payment request further comprises a payment request identifier, and wherein the payment-specific data included in the payment response comprises said payment amount, said payee alias, said payment request identifier and an alias of a payer being an intended sender of the offline digital payment, the computerized method further comprising, by the payee communication device, checking that the payment request identifier comprised in the payment-specific data included in the payment response matches the payment request identifier comprised in the payment-specific data included in the payment request as a further requisite for increasing the local balance of the payee digital wallet by the payment amount.

35. The computerized method as defined in claim 22, further comprising:
by the payee communication device, indicating in the payment request a version of the first cryptographic key comprised in its trusted execution environment, and
by the payer communication device, checking that the version of the first cryptographic key indicated in the payment request is the same as or compatible with a version of the first cryptographic key comprised in its own trusted execution environment.

36. The computerized method as defined in claim 22, further comprising:
by the payer communication device:
upon successful verification of the payment request, storing the payment-specific data included in the payment response as negotiated payment details for the offline digital payment in the trusted execution environment, and
subsequently making a payment settlement request by broadband data communication with the computerized payer account provider, wherein the payment settlement request includes the stored negotiated payment details for the offline digital payment and is signed by the second cryptographic key, and
by the payee communication device:
upon successful verification of the payment response, storing the payment-specific data included in the payment response as negotiated payment details for the offline digital payment in the trusted execution environment, and
subsequently making a payment settlement request by broadband data communication with the computerized payee account provider, wherein the payment settlement request includes the stored negotiated payment details for the offline digital payment and is signed by the third cryptographic key.

37. The computerized method as defined in claim 36, the payment-specific data included in the payment response comprising a payment identifier, wherein the method further comprises, by each of the payer communication device and the payee communication device:
upon successful verification of the payment request and the payment response, respectively, storing the negotiated payment details for the offline digital payment including said payment identifier in the trusted execution environment, and
including said payment identifier in the respective payment settlement request, thereby preventing double settlement of the offline digital payment.

38-41. (canceled)

42. A tangible, non-volatile computer readable medium having stored thereon a computer program comprising computer program code for performing the functionality of the payer communication device in the method according to claim 22 when the computer program code is executed by a processing device.

43. A tangible, non-volatile computer readable medium having stored thereon a computer program comprising computer program code for performing the functionality of the payee communication device in the method according to claim 22 when the computer program code is executed by a processing device.

44. A tangible, non-volatile computer readable medium having stored thereon a computer program comprising computer program code for performing the functionality of the computerized payer account provider in the method according to claim 22 when the computer program code is executed by a processing device.

45. A tangible, non-volatile computer readable medium having stored thereon a computer program comprising computer program code for performing the functionality of the computerized payee account provider in the method according to claim 22 when the computer program code is executed by a processing device.
